(19) United States
(12) Patent Application Publication
(10) Pub. No.: US 2024/0344485 A1
(43) Pub. Date: Oct. 17, 2024

(54) MERGED REFERENCE FINGERPRINT GENERATION FOR MACHINE-LEARNING DETECTION OF DEGRADED OPERATION

(71) Applicant: ORACLE INTERNATIONAL CORPORATION, Redwood Shores, CA (US)

(72) Inventors: Dmitriy ITKIS, Vancouver, WA (US); Guang Chao WANG, San Diego, CA (US); Ruixian LIU, San Diego, CA (US); Kenny C. GROSS, Escondido, CA (US)

(21) Appl. No.: 18/133,197

(22) Filed: Apr. 11, 2023

(51) Int. Cl. F02D 41/22; G06N 20/20

(52) U.S. Cl. CPC F02D 41/22; G06N 20/20

(57) ABSTRACT

Systems, methods, and other embodiments associated with a merged-surface 3D fingerprint technique for improved prognostics for assets are described. In one embodiment, a method includes generating a set of time series signals from sensor readings of a reference device while the reference device is operated through multiple individual iterations of an exercise profile. The reference device operates in a known undegraded state. The method then separates the set of time series signals into segments that correspond to the individual iterations of the exercise profile. The method then aligns and merges the segments to generate a merged reference fingerprint. The method then trains a machine learning model to detect anomalous departures from the known undegraded state based on the merged reference fingerprint.

### BACKGROUND

A digital twin of a device or asset may be used to perform prognostic analyses of the condition of assets deployed in the field (also referred to as field assets). Discrepancies between sensor telemetry produced by the digital twin and sensor telemetry produced by the field asset may indicate that the field asset is worn, damaged, misconfigured, failing, or otherwise degraded away from expected performance. Also, sensor telemetry from field assets may be sampled at a frequency that is higher than intake bandwidth of cloud services operating the digital twin.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a merged reference fingerprint system associated with a digital twin merged-surface 3D fingerprint technique for improved prognostics for assets, such as those assets that are monitored with high frequency waveforms.

FIG. 2 illustrates one embodiment of a merged reference fingerprint method associated with a digital twin merged-surface 3D fingerprint technique for improved prognostics for assets.

FIG. 3 illustrates one embodiment of a first pass, coarse alignment method to coarsely align segments of a 3D fingerprint.

FIG. 4 illustrates a 3D plot of an example 3D fingerprint scan of a golden system.

FIG. 5 illustrates a 3D plot of an example coarse merge of the six repetitions.

FIG. 6 illustrates one embodiment of a second pass, fine realignment method.

FIG. 7 illustrates an embodiment of a computing system configured with the example systems and/or methods disclosed.

### DETAILED DESCRIPTION

Systems, methods, and other embodiments are described herein that provide a digital twin merged surface 3D fingerprint technique for improved prognostics for assets, such as assets monitored with high frequency waveforms. In one embodiment, a 3D fingerprint is a collection of time series signals of amplitude values sampled from various frequency ranges of sensed activity by an asset. In one embodiment, a merged reference fingerprint system aligns and merges multiple reference fingerprints of a golden or reference system to reinforce signals and cancel noise in a merged fingerprint. A machine learning model trained to produce estimates consistent with the merged fingerprint may be employed as a digital twin against which operation of physical devices (referred to as field twins) may be compared for prognostic anomaly detection.

In one embodiment, a merged reference fingerprint system takes sensor readings from a reference device while the reference device repeats a test pattern of activity. The merged reference fingerprint system generates a collection of time series signals from the sensor readings. The collection of time series signals is separated into segments that line up with single occurrences of the test pattern. The segments are aligned with each other and merged into each other to produce a merged reference fingerprint. A machine learning model is trained to estimate undegraded operation (and detect anomalous departures from undegraded operation) based on the merged reference fingerprint.

For example, a machine learning model may be trained to be a digital twin for a given device type, such as a type of motor. Vibration sensor readings may be taken from a golden system motor of the type. The golden system motor is new, unworn and/or otherwise free of problems. The golden system motor is run in several iterations of a test sequence (or exercise profile) of motor speeds while being monitored by vibration sensors. The vibration sensor readings are converted from raw sensor readings into a set of time series signals. Each time series signal represents a vibration level of the motor within a particular frequency range at a sequence of points in time. The set of time series signals makes up a 3D fingerprint of the operation of the golden system motor. The set of time series signals may be cut into segments encompassing individual iterations of the test sequence. The individual iterations of the test are represented in the time series signals by similar waveforms. The segments may be aligned based on the waveforms of the test sequence. The aligned segments may then be merged together. The merge causes noise in the time series signals to be canceled. With the noise removal due to the merge of aligned segments, individual segments may be re-aligned with the other merged segments to increase the accuracy of the alignment of the individual segment, and then re-merged. The realignment reduces cancellation or deformation of the merged waveform. The merged segments make up a merged 3D fingerprint of the of the operation of the golden system motor that is improved in accuracy over the unmerged 3D fingerprint. A machine learning model is then trained to predict or estimate time series values for motors of the same type as the golden system motor based on the merged 3D fingerprint. The trained ML model may be operated as a digital twin for detecting degradation in motors of the same type that are deployed in the field.

In one embodiment, use of the merged reference fingerprint improves the technology of prognostic anomaly detection by increasing the accuracy of the digital representation of the activity (3D fingerprint) of the reference device through a merging procedure that reinforces signals and cancels noise. The prognostic accuracy of ML models used as digital twins is improved by training the ML model using the merged 3D fingerprint, resulting in reduced false alarm probabilities and/or reduce missed alarm probabilities when analyzing field twins for degradation in performance. In one embodiment, use of the merged reference fingerprint improves the technology of prognostic anomaly detection by reducing the scan time needed to detect the presence or absence of performance degradation in field twins. In one embodiment, the use of the merged reference fingerprint improves the technology of prognostic anomaly detection by enabling field twins that produce high-frequency waveforms to be monitored in the cloud based on 3D fingerprints, where bandwidth constraints would otherwise prevent monitoring of the high-frequency waveforms.

### Definitions

As used herein, the term “time series” refers to a data structure in which a series of data points or readings (such as observed or sampled values) are indexed in time order. In one embodiment, the data points of a time series may be indexed with an index such as a point in time described by a time stamp and/or an observation number. For example, a time series is one “column” or sequence of data points over multiple points in time from one of several sensors used to monitor an asset. As used herein, the terms “time series signal” and “time series” are synonymous. Occasionally, for convenience, a time series signal may be referred to simply as a “signal”.

As used herein, the term “vector” refers to a data structure that includes a set of data points or readings (such as observed or sampled values) from multiple time series at one particular point in time, such as a point in time described by a time stamp, observation number, or other index. For example, a “vector” is one row of data point sampled at one point in time from all sensors used to monitor an asset. A vector may also be referred to herein as an “observation”.

As used herein, the term “time series database” refers to a data structure that includes multiple time series that share an index (such as a series of points in time, time stamps, time steps, or observation numbers) in common. Or, from another perspective, the term “time series database” refers to a data structure that includes vectors or observations across multiple time series at a series of points in time, that is, a time series of vectors. As an example, time series may be considered “columns” of a time series database, and vectors may be considered “rows” of a time series database. A time series database is thus one type of a set of time series readings.

As used herein, the term “residual” refers to a difference between a value (such as a measured, observed, sampled, or resampled value) and an estimate, reference, or prediction of what the value is expected to be. For example, a residual may be a difference between an actual, observed value and a machine learning (ML) prediction or ML estimate of what the value is expected to be by an ML model. In one embodiment, a time series of residuals or “residual time series” refers to a time series made up of residual values between a time series of values and a time series of what the values are expected to be.

As used herein, the term “reference” as applied to a system, device, twin, or other asset refers to an instance of an asset that is a source of sensor readings that form a basis for training a machine learning model. This is in contrast to the term “field” or “test” as discussed below. In one embodiment, a “reference” asset may further be a “golden” asset.

As used herein, the term “golden” as applied to a system, device, twin, or other asset refers to an instance of an asset that is confirmed to be operating without degradation, for example, without substantial problems, wear, damage, defects, or other degradations. In one embodiment, a golden asset provides a standard of “correct” or expected behavior for undegraded assets of a given type.

As used herein, the terms “field” or “test” as applied to a system, device, twin, or other asset refers to an instance of an asset that is a source of sensor readings that form a basis for a comparison with estimates by the trained machine learning model in order to detect degradation of performance of the field asset. A “field” asset is thus a unit being examined for degradations, while a “reference” or “golden” asset is a unit which provides a standard of operation. In one example, a “field” asset has been deployed in the field to perform its functions.

As used herein, the term “3D fingerprint” of an asset refers to a time series database or other group of time series signals that are sampled from frequency bins (ranges) of sensor readings of the asset. In one embodiment, a 3D fingerprint represents sensed activity of an asset in three dimensions-time, frequency, and amplitude. In one embodiment, a 3D fingerprint provides a signature of the behavior of the asset based on the sensor readings.

As used herein, the term “digital twin” refers to a digital or computer representation of a physical asset. In one embodiment, a digital twin may be used for prognostic anomaly detection in instances of the physical asset and for simulation of behavior of the physical asset. In one embodiment, a machine learning model trained based on a merged 3D fingerprint of a physical asset (as shown and described herein) may be used as a digital twin of the physical asset.

### —Example Merged Reference Fingerprint System—

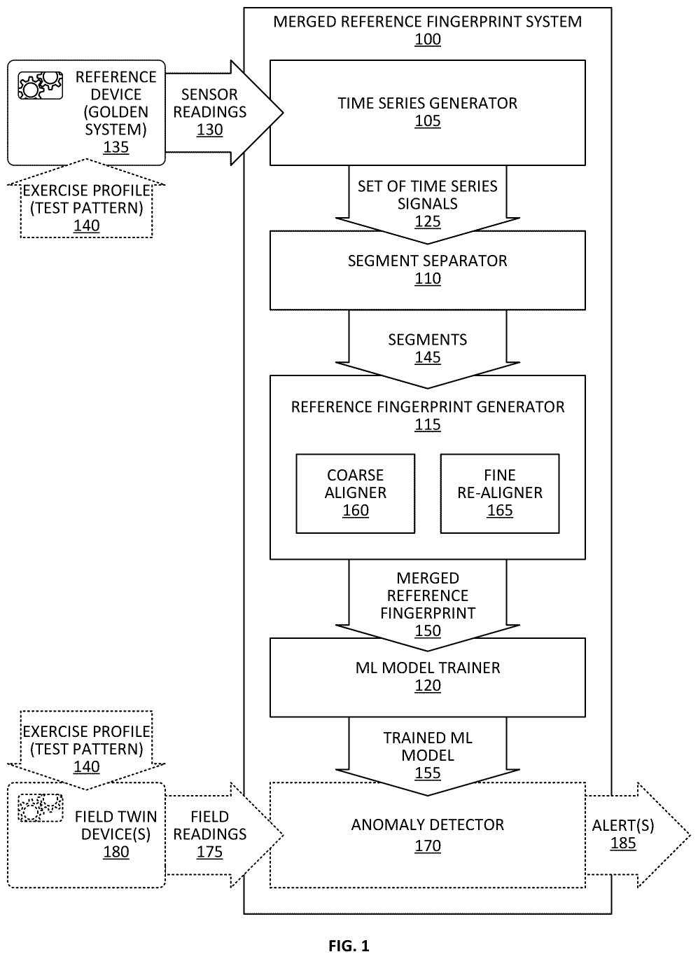

FIG. 1 illustrates one embodiment of a merged reference fingerprint system 100 associated with a digital twin merged-surface 3D fingerprint technique for improved prognostics for assets (such as assets monitored with high frequency waveforms). Merged reference fingerprint system 100 includes components for creating a merged reference fingerprint for digital twin analyses based on repeated readings from a reference device. In one embodiment, the components of merged reference fingerprint system 100 include time series generator 105, segment separator 110, reference fingerprint generator 115, and ML model trainer 120.

In one embodiment, time series generator 105 is configured to generate a set of time series signals 125 from sensor readings 130 of a reference device 135 (or golden system). The sensor readings 130 are taken while the reference device 135 is operated through multiple individual iterations of an exercise profile 140 (or test pattern). Reference device 135 operates with a known state of degradation, such as a state known to be undegraded. For example, for a golden system fingerprint (that is, to prepare a 3D fingerprint of a golden system), the reference device 135 runs the exercise profile while in an undegraded state in which the reference device 135 free of degradation due to wear, damage, or other degradation modes.

In one embodiment, segment separator 110 is configured to separate the set of time series signals 125 into segments 145 that correspond to the individual iterations of the exercise profile. In one embodiment, reference fingerprint generator 115 is configured to align and merge the segments 145 to generate a merged reference fingerprint 150. In one embodiment, ML model trainer 120 is configured to train a machine learning model 155 to detect anomalous departures from the known state of degradation (or known undegraded state) based on the merged reference fingerprint 150.

In one embodiment, the reference fingerprint generator 115 includes a coarse aligner 160 and a fine re-aligner 165. In one embodiment, coarse aligner 160 is configured to coarsely align the segments 145 based on cross correlation coefficients between the segments 145 to generate a coarse reference fingerprint. The coarse reference fingerprint is a merge of the segments 145 after they have been coarsely aligned. In one embodiment, fine re-aligner 165 is configured to finely realign the segments 145 based on cross power spectral density between individual segments 145 extracted from the coarse reference fingerprint and the coarse reference fingerprint to generate the merged reference fingerprint. The merged reference fingerprint is a merge of the segments 145 after they have been finely realigned.

In one embodiment, the components of merged reference fingerprint system 100 further include an anomaly detector 170. In one embodiment, anomaly detector 170 is configured to monitor field readings 175 of a field twin device 180 with the trained machine learning model 155 to detect an anomaly indicating degraded operation of the field twin device 180. In one embodiment, the field twin device is operated through an iteration of the exercise profile 140 during the monitoring. In response to detecting the anomaly, anomaly detector 170 is configured to generate an electronic alert 185 that the field twin device 180 exhibits degraded operation.

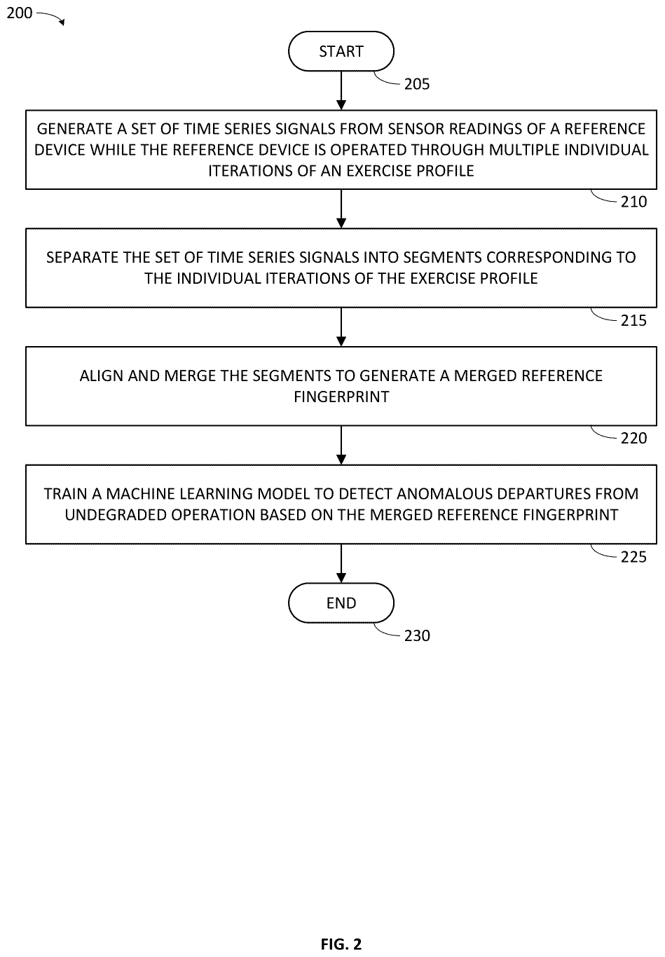

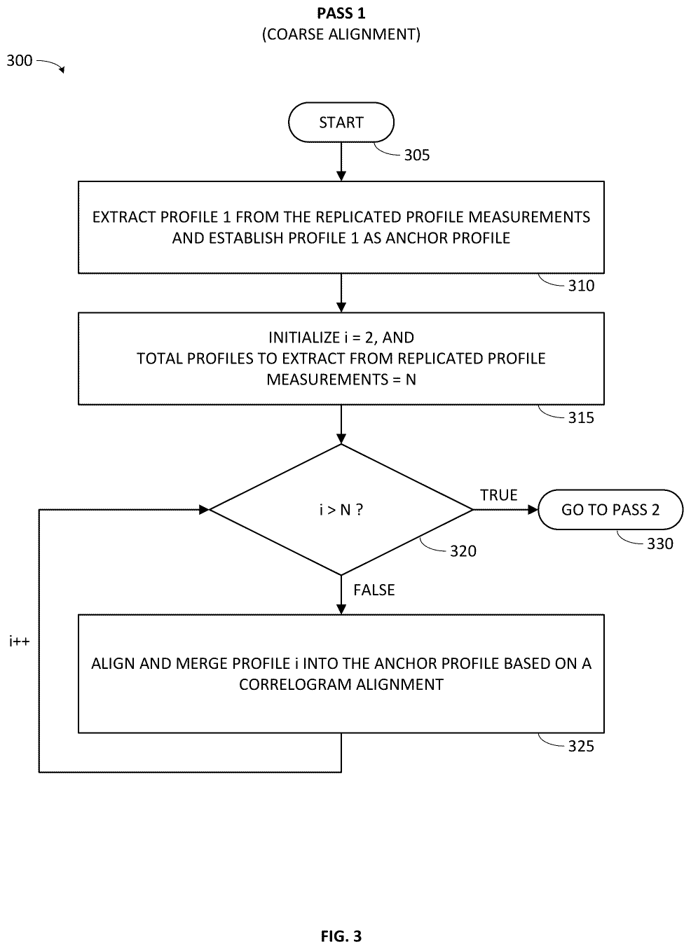

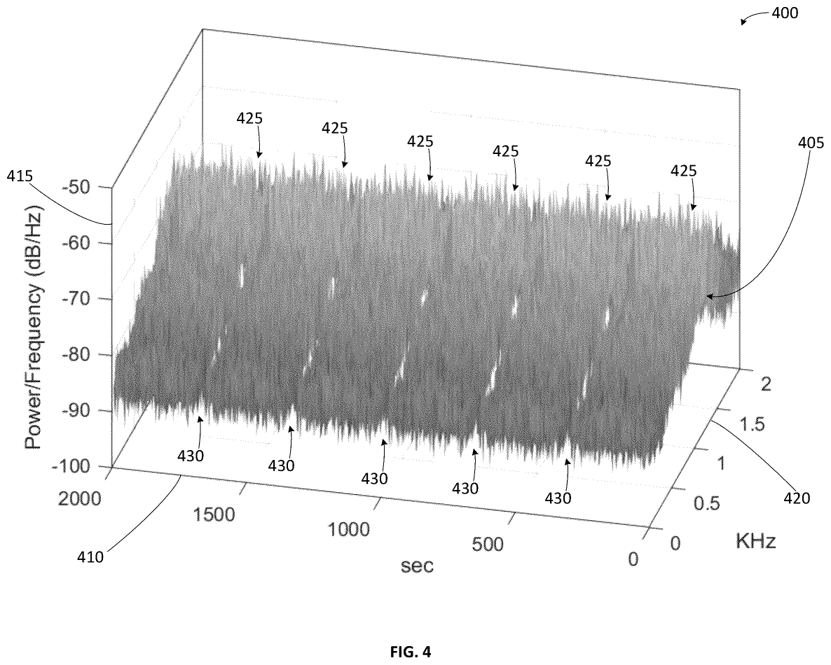

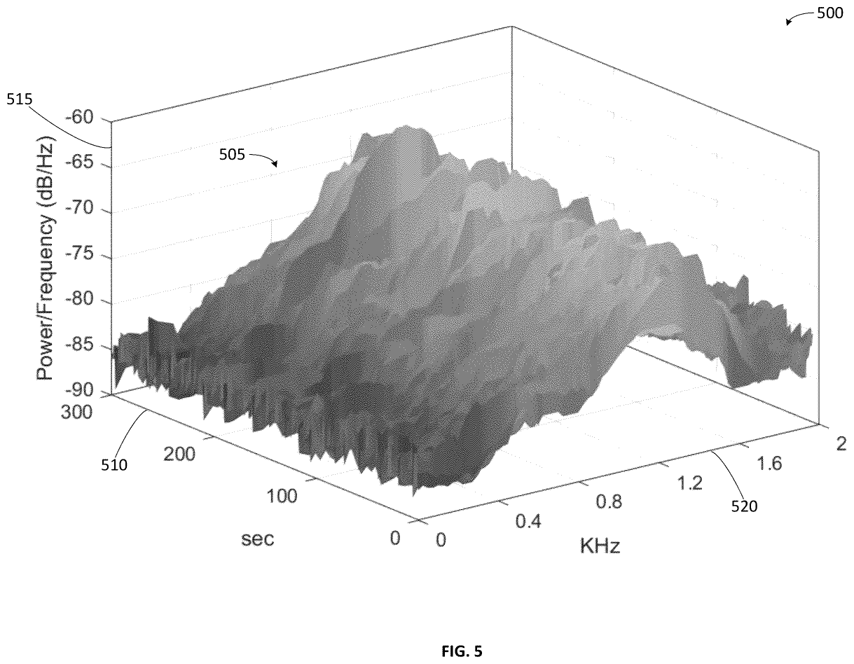

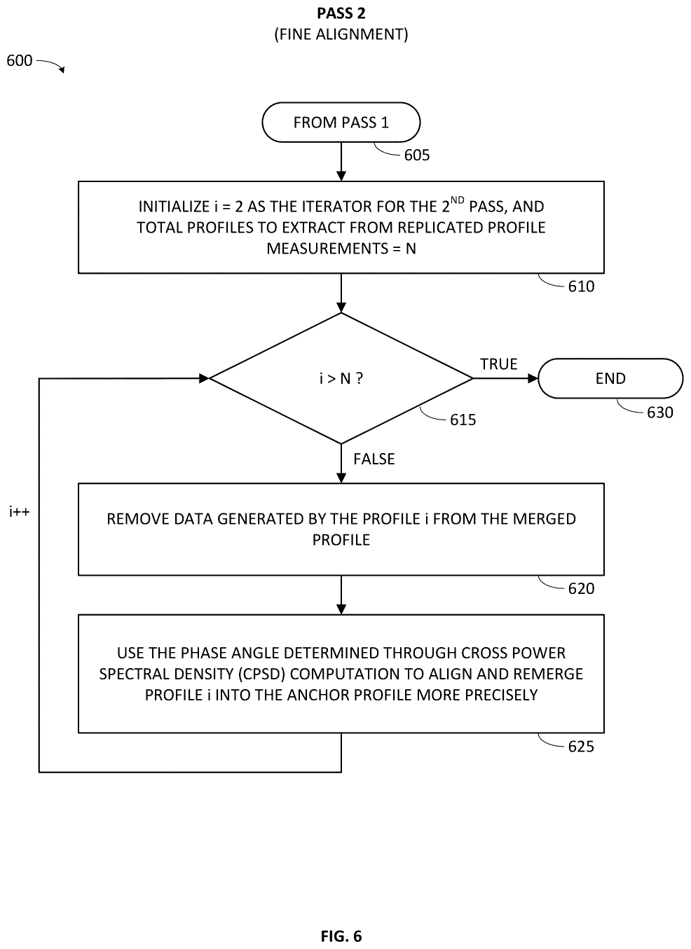

Further details of merged reference fingerprint system 100 are presented herein. In one embodiment, the operation of merged reference fingerprint system 100 will be described with reference to example merged reference fingerprint method 200 of FIG. 2. In one embodiment, additional detail of a first pass, coarse alignment will be shown and described with reference to first pass, coarse alignment method 300 of FIG. 3, and with reference to 3D plots 400 and 500 of FIGS. 4 and 5, respectively. In one embodiment, additional detail of a second pass, fine alignment will be shown and described with reference to second pass, fine realignment method 600 of FIG. 6.

### —Example Merged Reference Fingerprint Method—

FIG. 2 illustrates one embodiment of a merged reference fingerprint method 200 associated with a digital twin merged-surface 3D fingerprint technique for improved prognostics for assets, such as those monitored with high frequency waveforms. As an overview, in one embodiment, merged reference fingerprint method 200 generates a set of time series signals from sensor readings of a reference device while the reference device is operated through multiple individual iterations of an exercise profile. The reference device operates with a known state of degradation, such as operating in an undegraded state. Merged reference fingerprint method 200 then separates the set of time series signals into segments that correspond to the individual iterations of the exercise profile. Merged reference fingerprint method 200 then aligns and merges the segments to generate a merged reference fingerprint. Merged reference fingerprint method 200 then trains a machine learning model to detect anomalous departures from the known state of degradation based on the merged reference fingerprint.

In one embodiment, merged reference fingerprint method 200 initiates at START block 205 in response to a merged reference fingerprint system 100 determining one or more of: (i) that merged reference fingerprint system 100 has received sensor readings 130 from reference device 135; (ii) that an instruction to perform merged reference fingerprint method 200 has been received; (iii) a user of merged reference fingerprint system 100 has initiated merged reference fingerprint method 200; (iv) a signal has been received that indicates that reference device 135 has begun to be operated through iterations of the exercise profile 140; (v) that merged reference fingerprint system 100 has received previously recorded sensor readings 130 from storage; (vi) or that merged reference fingerprint method 200 should commence in response to occurrence of some other condition. In one embodiment, a computer system configured to execute functions of merged reference fingerprint system 100 performs merged reference fingerprint method 200. Following initiation at start block 205, merged reference fingerprint method 200 continues to process block 210.

### —Example Merged Reference Fingerprint Method—TSS Generation—

At process block 210, merged reference fingerprint method 200 generates a set of time series signals from sensor readings of a reference device while the reference device is operated through multiple individual iterations of an exercise profile. In one embodiment, the sensor readings are converted to a collection of concurrent time series signals. The reference device operates with a known state of degradation. For example, the reference device operates in a state that is known to be undegraded. Thus, in one embodiment, sensor readings are taken from a reference asset that is working in perfect order and turned into a 3D fingerprint of the operation of the reference asset.

In one embodiment, the reference device is an instance of an asset of a given type (make, model, configuration, etc.) that has been selected to be a standard of operation for assets of the given type. The reference device is used to generate sensor readings of how assets of the given type are expected to perform. The expected performance is associated with a known extent of degradation of the asset. Generally, the reference device is an asset that is confirmed to be free of degradation, and therefore may also be referred to as a “golden system”. In other words, the reference device is operating without problems. For example, the reference device may be confirmed to be free of defects due to wear, aging, damage, or other degradation modes. And, for example, the reference device may be confirmed to be configured according to specifications. Further, for example, the reference device may be confirmed to be provided with inputs specified for assets of the given type, such as fuels, lubricants, feedstocks, power supply, etc. The reference device is thus at a state of degradation that is known-confirmed empirically by observation—to be undegraded. Sensor readings taken while the reference device is being operated will therefore represent “correct” or expected behavior by assets of the given type.

In one embodiment, the reference device is operated through multiple iterations of an exercise profile. The exercise profile is a deterministic (that is, pre-determined) test pattern and/or test sequence of power or load levels placed on the reference device over time. Thus, the reference device is repeatedly run with a test pattern. Cycling the reference device through the exercise profile several times puts the reference device through its paces in a repeated series of activity. The power or load placed on the reference device are increased and/or decreased in a pre-determined pattern that covers various levels of operation, for example, idle through maximum or other range of activity available to assets of the given type. In one embodiment, the exercise profile may be a sinusoid, powering on and off repeatedly, throttle or other transitions between power or activity levels, for example cycling between minimum and maximum power (and back) one or more times within a time period. In one embodiment, environmental parameters may be varied as well, for example by setting an ambient temperature, ambient humidity, or other ambient condition for the reference device. Operation of the reference device through the exercise profile thus elicits behavior of the reference device during a particular state of operation, such as undegraded operation under given environmental conditions.

In one embodiment, the exercise profile is repeated to occur more than one time. The reference device thus operates through several iterations of the exercise profile. Because the pattern of the exercise profile recurs, sensor readings of the operation with multiple occurrences of the exercise profile are in effect replicated scans of operation in the exercise profile, in which the exercise profile is performed repeatedly to produce consistent sequences of time series readings. The pattern of changes in power or load on the reference device may be stacked or merged atop each other to reinforce signals produced, and cancel out noise. For example, 3D fingerprints of the reference device operating through one iteration of the exercise profile may be merged to increase accuracy of the 3D fingerprint by reinforcing time series content that represents activity of the reference device, and canceling out noise that does not represent the activity of the reference device.

Rest periods may be included between the individual iterations of the exercise profile. In one embodiment, rest periods may also precede and follow the initial and final iteration of the exercise profile. The rest periods are periods of flat signal values, for example, signals having a stationary mean that is not decreasing or increasing. For example, the rest periods may be due to a pause in change of operation level of the reference device, or a return to an idle state of the reference device. The rest period signals may be noisy, for example including white noise around the stationary mean. The rest periods provide time ranges in which time series signals representing individual iterations of the exercise profile may be separated into segments. The rest periods are flat so that when the time series signals for individual iterations are separated into segments, the segments can include stubs of flat values to accommodate adjustment of lead/lag time for alignment of waveforms. In one embodiment, the rest periods have a given length. For example, each rest period may be 30 seconds, 1 minute, etc. Or, in one embodiment, the rest period may be less than ⅕ the length of the exercise profile. Or, in one embodiment, the rest period may be an amount of time sufficient to allow lead/lag adjustment to accommodate alignment of the waveforms of the exercise profile, for example twice a period of repeating activity in the exercise profile.

In one example, the reference device may be scanned for a total of just over an hour, while performing six iterations of a 10-minute exercise profile separated by brief, 30 second rest periods (a total of 1 hour, 2 minutes, and 30 seconds). Sensor readings of the reference device during this period of operation may be converted into a 3D fingerprint of the activity of the reference device.

In one embodiment, the sensors are transducers for converting physical phenomena such as acoustic, ultrasonic, vibration, electromagnetic interference (EMI), infrared (IR) thermal outputs into sensor readings. In one embodiment, sensors are placed within, upon, proximate to, directed at, or otherwise positioned in a configuration to receive or capture output from the reference device or asset. In one embodiment, a sensor may also be referred to as a “scanner”. In one embodiment, the sensors transmit the sensor readings to the merged reference fingerprint system for conversion to a 3D fingerprint or other set of time series signals.

In one embodiment, the sensor readings are electrical signals or amplitude values produced by sensors. In one embodiment, the sensors produce values at a high frequency. The sensor readings may thus have a high sampling rate, as discussed in further detail herein. In one embodiment, the sensor readings have a sampling rate at or above the Nyquist rate (twice the frequency of the highest frequency output intended to be recorded by the sensors). Thus, the sensor readings may be sampled at a high rate, especially for vibration, ultrasonic, and EMI readings. The sensor readings may be recorded to storage, or processed by time series generator 105 in real time.

In one embodiment, the sensor readings are subjected to a spectrum analysis to characterize a broad frequency spectrum of the sensor readings with a spectrum analyzer. In one embodiment, the spectrum analyzer takes sensor readings and converts the sensor readings to an amplitude waveform over the spectrum of frequencies. In one embodiment, amplitude waveforms are produced at a sampling interval, such as at the sampling rate discussed above. The sensor readings are thus characterized or represented over time as a series of amplitude waveforms across the frequency spectrum.

In one embodiment, the frequency spectrum may be divided or partitioned into frequency bins. A frequency bin covers a range of frequencies within the frequency spectrum. In one embodiment, the frequency bins are contiguous ranges of the frequency spectrum. In one embodiment, the frequency bins are discrete and do not overlap. In one embodiment, the frequency bins are of approximately equal width, covering similar ranges of the frequency spectrum. In one embodiment, the frequency spectrum is divided into 100 bins. In one embodiment, a frequency bin may be represented by a representative frequency. The representative frequency may be a component frequency within the frequency bin. For example, the representative frequency may be a frequency on which the bin is centered, at a mid-point of the range covered by the bin. Or, for example, the representative frequency may be a frequency among those within the bin that has highest peaks or that has greatest changes in amplitude. In one embodiment, the representative frequency may be an aggregate frequency, such as an average (mean or median) of amplitudes across the frequencies in the bin.

In one embodiment, a set of time series signals are sampled from the frequency bins to produce a 3D fingerprint of the reference device (or other asset monitored by the sensors). In one embodiment, the set of time series signals are sampled from distinct frequency bins. More particularly, a time series signal is generated by sampling amplitude values at an interval from a representative frequency of one of the frequency bins. The sampling is performed for multiple bins to produce multiple time series signals, with one time series signal corresponding to each of the multiple bins. Thus, a time series signal corresponds to a frequency bin where the time series signal is generated by sampling from the frequency bin.

In one embodiment, the samples are taken at concurrent times from each frequency bin. In one embodiment, the interval at which the samples are taken from each frequency bin is a lower sampling rate than the high sampling rate of the sensor readings.

In one embodiment, the 3D fingerprint includes time series signals for each of the frequency bins. In one embodiment, the 3D fingerprint includes time series signals for a subset of the frequency bins. For example, the 3D fingerprint may include a percentage N, such as N=10%, of frequency bins. In one embodiment, the percentage N of frequency bins with representative frequencies that have the highest power spectral density (PSD) peaks may be automatically selected to be sampled into time series for the 3D fingerprint.

In this way, the sensor readings may be converted into the set of time series signals. The set of time series signals converted from the sensor readings of the reference device make up a three-dimensional (3D) fingerprint of the reference device. Thus, in one embodiment, the set of time series signals—the 3D fingerprint—is a time series database. Having a plurality of lower sampling rate time series signals that correspond to various frequency bins creates a far more compact representation of the sensed activity of an asset, while retaining information about the high frequency activity of the asset. Further, the arrangement of the 3D fingerprint as multiple time series signals advantageously renders many processing operations naturally parallelizable on discrete processors.

Thus, in one embodiment, merged reference fingerprint method 200 generates a set of time series signals from sensor readings of a reference device while the reference device is operated through multiple individual iterations of an exercise profile by accepting sensor readings of a reference device being operated with a repeating exercise profile, dividing a frequency spectrum of the sensor readings into frequency bins, and repeatedly sampling amplitude values at an interval from a set of the frequency bins to generate the set of time series signals. In one embodiment, the generation of the set of time series signals from sensor readings described in process block 210 is performed by time series generator 105. In one embodiment, at the completion of process block 210, a 3D fingerprint of the reference device has been created that includes more than one replication of a scan of the exercise profile. This 3D fingerprint of multiple iterations of the exercise profile may be separated into segments for individual iterations, as discussed below.

### —Example Merged Reference Fingerprint Method—Separation of Segments—

At process block 215, merged reference fingerprint method 200 separates the set of time series signals into segments corresponding to the individual iterations of the exercise profile. In other words, the 3D fingerprint of multiple passes through the exercise profile is split into separate 3D fingerprints for each pass through the exercise profile. The set of time series signals that make up the 3D fingerprint is divided between the individual iterations to produce the segments.

In one embodiment, a segment of the set of time series signals (that is, of the 3D fingerprint) is a portion of the set of time series signals covering less than the whole range of time indexes for the time series signals. In one embodiment, merged reference fingerprint method 200 separates the time series signals into segments by subdividing the time series signals by time range. Time ranges encompassing individual iterations or the exercise profile are cut out of the overall time series signal to produce the segments. For example, merged reference fingerprint method 200 selects the time indexes which correspond to a range encompassing one individual iteration of the exercise profile to be included in a segment for the individual iteration. Thus, the time series signals are filtered to remove signal values not associated with the individual iteration, and to retain signal values that are associated with the individual iteration.

In one embodiment, merged reference fingerprint method 200 identifies a beginning point and an ending point for each segment. The beginning points and ending points may be, for example, index positions within the time series signals. A pair of a beginning point and an ending point brackets an individual iteration of the exercise profile (and, in some cases, the stubs on either side of the exercise profile) within the set of time series signals. Then, for each pair of beginning point and ending point, merged reference fingerprint method 200 stores the portion of each of the time series signals between the beginning point and ending point (inclusive) as a separate segment. The segment may also be referred to herein as a “profile”, or more informally as a “chunk”. Merged reference fingerprint method 200 thus truncates the set of time series signals at various points to produce the segments.

In one embodiment, merged reference fingerprint method 200 divides the set of time series signals in the rest periods between individual iterations. In one embodiment, the division between the segments is made in the middle of the rest periods, for example splitting the rest period approximately in half to leave flat stubs or tabs at either end of the segments. Or, in one embodiment, the range of the segments is chosen to cover a specified amount outside of the iteration, for example, up to and including the entire rest period on either end. Thus, in one embodiment, the stubs on either end of a segment may overlap with stubs on the ends of adjacent segments.

In one embodiment, the segments correspond to an individual iteration of the exercise profile (test pattern) by encompassing one iteration, and not to other iterations. Thus, in one embodiment, the time range of an individual segment (including the buffer stubs or tabs at either end) covers or surrounds the time range of the iteration without extending into the time ranges of other iterations, in whole or in part. Segments are contemporaneous ranges (having same series of indexes) of vectors across the set of time series signals.

Referring again to the example of the approximately 1-hour scan of the reference device, the time series signals may be separated into six approximately 10-minute segments that correspond to the six individual iterations of the exercise profile.

Thus, in one embodiment, merged reference fingerprint method 200 separates the set of time series signals into segments corresponding to the individual iterations of the exercise profile by identifying beginning points and ending points surrounding each individual iteration, selecting the sequence of values in each of the set of time series signals that fall between the beginning and ending points to be a segment, and storing the sequence values selected (for one segment) from each of the set of time series signals as a separate time series signal. In one embodiment, this produces a collection of segments (of the set of time series signals) that are truncated to correspond to unique individual iterations of the exercise profile. In one embodiment, the separation of the set of time series signals into segments described in process block 215 is performed by segment separator 110. In one embodiment, at the completion of process block 215, In one embodiment, the segments are 3D fingerprints of replicated scans of the reference device executing the exercise profile. These multiple segments may be aligned based on the waveform of the exercise profile and merged to produce a merged 3D fingerprint of the reference device executing the exercise profile.

### —Example Merged Reference Fingerprint Method—Align and Merge Segments—

At process block 220, merged reference fingerprint method 200 aligns and merges the segments to generate a merged reference fingerprint. Aligning the segments lines up curves of the waveform between segments. Merging the segments combines the lined-up segments into a single set of the time series signals. Time series signals in separate segments that correspond to the same frequency bin are merged into a single merged time series signal or merged 3D fingerprint.

In one embodiment, the merged reference fingerprint method 200 aligns the segments with each other. In one embodiment, as used herein, “aligning” the segments refers to adjusting the segments forward/backward in time so that the waveform of the exercise profile in each of the segments lines up. In one embodiment, the merged reference fingerprint method 200 moves one or more segments in the time dimension to cause waveforms of the segments to overlap. Individual segments are phase-shifted by an amount of time that causes the features of the exercise profile waveform (such as peaks and troughs) to be coordinated in time between the segments. The time adjustment advances or delays the segments.

In one embodiment, the alignment and merge of segments into a merged 3D fingerprint is performed in two passes. In a first pass, segments are advanced or delayed in time to bring their waveforms into an approximate or coarse alignment, and the aligned segments are merged. In a second pass, each individual segment is, in turn: pulled back out of the merged segments, further adjusted in time to improve alignment of the waveform of the individual segment with the waveform of the other merged segments, and re-merged into the merged segments.

In the first pass, the alignments are calculated using a less computationally expensive—although less accurate-algorithm. In one embodiment, the alignments in the first pass are based on a cross correlation coefficient (CCC). In one embodiment, CCC between a stationary anchor segment and an offset segment that is to be moved into alignment with the anchor segment indicates how aligned the offset segment and anchor segment are. In one embodiment, in the first pass, merged reference fingerprint method 200 finds a lead/lag adjustment to each offset segment that coarsely aligns each offset segment to an anchor segment. The lead/lag adjustment is identified by a process of iteratively incrementing the lead/lag adjustment to the offset segment by an amount and determining the CCC between the offset segment as adjusted and the anchor segment until the CCC is maximized. The lead/lag adjustment that results in the maximum CCC is applied to the offset segment, and the offset segment is merged into the anchor profile with time indexes shifted by the lead/lag adjustment. The first pass provides coarse alignment between the merged segments.

The alignments are considered to be “coarse” because the alignment based on the CCC is a rough or approximate alignment that can be improved in a second pass. In one embodiment, the initial coarse alignment causes much noise to be canceled out in a merged 3D fingerprint. The coarsely aligned merged segments provide a reference for a second pass which further improves the alignments in the merged 3D fingerprint. Thus, as used herein with reference to alignment, the term “coarse” indicates that the alignment is a preliminary, approximate alignment that is to be improved based on a more precise algorithm.

In one embodiment, in the first pass the merge process iteratively aligns and merges offset segments one at a time into the anchor segment. For each offset segment, the merged reference fingerprint method 200 determines how much lead/lag adjustment is needed to align the offset segment with the anchor segment, adjusts the lead/lag of the offset segment, and merges the offset segment into the anchor segment.

In a second pass, the alignments are adjusted within the coarsely merged fingerprint to increase the accuracy of the fingerprint. In the second pass the alignments are adjusted using a more accurate- and more computationally expensive-algorithm to fine tune the alignment between component segments of the merged fingerprint. In one embodiment, the alignments in the second pass are based on a cross power spectral density (CPSD). In one embodiment, CPSD between one offset segment extracted from the merged 3D fingerprint created in the first pass and the remaining merged segments in the merged 3D fingerprint indicates how well aligned the extracted offset segment is with the rest of the merged 3D fingerprint. In one embodiment, in the second pass, merged reference fingerprint 200 finds a further lead/lag adjustment to each offset segment to finely re-align each offset segment to the merged 3D fingerprint. The realignment is an shift from the initial coarsely aligned position to a position which more precisely aligns the waveforms of the exercise profile in the merged segments. The additional fine lead/lag adjustment is identified by determining a CPSD phase angle between the offset segment and the rest of the merged 3D fingerprint. The resulting CPSD phase angle is then used as the additional fine lead/lag adjustment. Thus, in the second phase when using CPSD to find how much to advance or delay an individual segment with respect to the other merged segments, the fine lead/lag adjustment is derived directly, without iterative incrementation as in phase 1. The additional fine lead/lag adjustment is applied to the offset segment. And, the offset segment is merged back into the anchor profile with time indexes shifted by both the initial coarse lead/lag adjustment of the first pass and the additional fine lead/lag adjustment of the second pass. The lead/lag adjustments from the first and second passes are thus cumulative. The second pass provides fine alignment between the merged segments.

The realignments in the second pass are considered to be “fine” because the alignment based on the CPSD is a more precise alignment than that achieved by the CCC in the first pass. In one embodiment, the fine realignment is corrected with respect to the initial errors or deviations from the initial coarse alignment in the first pass. Use of the CPSD to refine the alignment between the component segments of the merged 3D fingerprint using the remaining merged segments as a reference further improves the alignment due to the reduction of noise in the remaining merged segments. Thus, as used herein with reference to alignment, the term “fine” indicates that the alignment is a subsequent, adjusted alignment that adjusts an initial coarse alignment to improve the precision of the overlap of the waveforms.

In one embodiment, in the second pass the merge process iteratively extracts an offset segment from, realigns the offset segment with, and re-merges the offset segment into the merged 3D fingerprint. For each offset segment, the merged reference fingerprint method 200 identifies how much additional lead/lag adjustment will increase the precision of the alignment between the offset segment and the merged 3D fingerprint (merged anchor segment), adjusts the lead/lag of the offset segment by the additional lead/lag amount, and reinserts the offset segment back into the merged 3D fingerprint (merged anchor segment).

In one embodiment, merged reference fingerprint method 200 initially sets an anchor segment. In one embodiment, the anchor segment is set in the first pass. In one embodiment, one of the segments is designated to be an anchor segment. The anchor segment may be the first segment in order of performance of the exercise profile, or may be one of the other, subsequent segments. The anchor segment is not advanced or delayed, but left in place. The anchor segment provides a reference against which segments other than the anchor segment may be aligned by advancing or delaying the segment. In other words, the anchor segment establishes the position in time of the waveform against which other segments will be advanced or delayed to align. In one embodiment, the segment chosen to be anchor segment is not changed over the course of alignment and merging.

In one embodiment, the time adjustment increases a lead (and decreases a lag) of the segment with reference to the anchor segment to advance the segment, or increases the lag (and decreases the lead) of the segment with reference to the anchor segment to delay the segment. The time adjustment may therefore also be referred to as a lead/lag adjustment, offset, or delta. In one embodiment, merged reference fingerprint method 200 determines a lead/lag adjustment to the offset segment that causes the exercise profile in the offset segment to align with the exercise profile in the anchor segment. In other words, a lead/lag adjustment is determined that causes a waveform of the offset segment to align with a waveform of the anchor profile.

In one embodiment, the lead/lag adjustment is found by repeatedly or iteratively determining an alignment score for a current lead/lag adjustment and incrementing the current lead/lag adjustment by an amount of time until the alignment score no longer improves. In one embodiment, the increment may be reversed or made negative where the alignment score does not improve, in order to ensure progress towards a most improved alignment score. In one embodiment, reversing back and forth between two current lead/lag adjustments indicates that the lead lag adjustment is the lead/lag adjustment with the better of the two alignment scores. Other algorithms may also be used to determine the lead/lag adjustment based on optimizing an alignment score.

In one embodiment, the alignment score may be, or be based on, a cross correlation coefficient (CCC) between the offset segment and the anchor segment, for example in the first pass. When using the CCC as the alignment score, the alignment score improves as the CCC between the offset segment and the anchor segment increases. The lead/lag adjustment is found where the CCC is maximized. In one embodiment, the alignment score may be, or be based on, a cross power spectral density (CPSD) phase angle or phase shift between the offset segment and the anchor segment, for example in the second pass. When using the CPSD phase angle as the alignment score, the alignment score improves as the CPSD phase angle between the offset segment and the anchor segment decreases. The lead/lag adjustment is found where the CPSD phase angle is minimized. As discussed in further detail below, alignment based on CCC may be performed in a first pass, followed by a second pass of realignment or fine tuning of alignment based on CPSD.

The segments are 3D fingerprints made up of time series signals for each of a set of frequency bins. So, in one embodiment each of the component time series signals of a segment is adjusted by the time amount in lockstep. The time adjustment is applied to the time indexes of the time series signals in a segment. For example, the time adjustment is added to the time indexes of a segment to advance the segment, and subtracted from the time indexes of a segment to delay the segment. Merged reference fingerprint method 200 thus shifts segments to a positions to cause waveforms in the component time series signals to be synchronized.

In one embodiment, merged reference fingerprint method 200 merges the aligned segments with each other. In one embodiment, segments are merged into the anchor segment after being aligned with the anchor segment. The values of an offset segment (the adjusted segment that is being merged into the anchor segment) are inserted into the anchor segment at adjusted time indexes. The anchor segment thus receives additional values at time indexes adjusted by the lead/lag offset. For example, values from the offset segment are written into the anchor segment at the adjusted time indexes. Because the time indexes are adjusted by the lead/lag offset, the values from the offset segment are interposed among the values that were already present in the anchor profile. This insertion or interposition is performed for each pair of corresponding anchor time series signal (from the anchor segment) and offset time series signal (from the offset segment that is being merged) for a given frequency bin. In this way, the anchor segment becomes progressively denser with values as offset segments are merged into it. Merging offset segments into the anchor segment results in one time series segment, the anchor segment that includes values from the offset segments. In this way, the anchor segment becomes a merged 3D fingerprint. The individual segments may be extracted for adjustment, and then re-merged into the anchor segment/merged 3D fingerprint in a similar manner.

Thus, in one embodiment, merged reference fingerprint method 200 aligns and merges the segments to generate a merged reference fingerprint by: setting one segment to be an anchor segment; aligning each offset segment (additional segment other than the anchor segment) with the anchor segment and merging the additional segment into the anchor segment based on CCC between the additional segment and anchor segment; extracting each offset segment in turn, realigning the offset segment based on CPSD between the extracted offset segments and the merged segments, and re-merging the realigned offset segment back into the anchor segment. In one embodiment, the aligning and merging of the segments to generate a merged reference fingerprint of process block 220 is performed by reference fingerprint generator 115. For example, the first pass may be performed by coarse aligner 160, and the second pass may be performed by fine re-aligner 165. In one embodiment, at the completion of process block 220, a merged 3D fingerprint for the reference device has been created. In one embodiment, the merged fingerprint lines up the waveforms of the exercise profile in each segment so as to cancel out noise and reduce or minimize destructive interference of the exercise profile due to misalignment. The merged 3D fingerprint resulting from the segments merged and aligned in this manner is a more accurate representation of the activity of the reference device than are the unmerged segments, thus improving the prognostic accuracy of any model trained based on the merged 3D fingerprint of the reference device.

In one embodiment, the 3D fingerprint of multiple passes through the exercise profiles is a single 3D surface. Separating the 3D fingerprint of multiple passes into segments produces multiple separate 3D surfaces. Aligning the 3D surfaces and merging the aligned 3D surfaces thus produces a merged-surface 3D fingerprint, also referred to herein as a merged 3D fingerprint.

In one embodiment, after the alignment and merging of the segments into the merged reference fingerprint at process block 220, still more noise may be removed by ensemble averaging of the merged signals that make up the merged reference fingerprint in a moving window. In one embodiment, merged reference fingerprint method 200 further ensemble averages the merged signals. In one embodiment, the ensemble averaging replaces each signal value with an average (such as a mean or median) value of the signal values occurring within a window centered on the signal value. In one embodiment, the width of the window is measured by index position. For example, a window may cover a number S of seconds (e.g., S=10) on either side of the index position of a signal value, and average all signal values with index positions within that window. In one embodiment, the width of the window is measured by quantity of values. For example, a window may cover a quantity V of values surrounding a signal value, such as the nearest 20 values (V=20) in the time series.

In one embodiment, the alignment and merging of segments at process block 220 may result in the merged time series signals of the merged reference fingerprint having indexes with non-uniform spacing, thus having differing amounts of time between values. The spacing between values may instead be based on the lead/lag adjustments to the various merged segments. Thus, in one embodiment, merged reference fingerprint method 200 further resamples the merged time series signals to uniform spacing in order to have a single amount of time between values. In one embodiment, a spacing increment of time between index positions is set. The spacing increment may be predetermined. In one embodiment, the spacing increment is under 1 minute. In one embodiment, a spacing increment of 1 second is used. The merged time series signals are then substituted with interpolated time series signals generated from the merged time series signals. The interpolated time series signals have interpolated values occurring at the spacing increment. The interpolated values are generated (estimated or calculated) from the values in the merged time series signal. The merged reference fingerprint may then be made up of interpolated signals with values set apart uniformly by the spacing increment.

Referring again to the example of the approximately 1-hour scan of the reference device, the six approximately 10-minute segments may be aligned and merged in order to produce a single, approximately 10-minute merged 3D fingerprint of the reference device. In a first pass, one of the 10-minute segments is set as anchor profile, and the other 10-minute segments are aligned with and merged into the anchor segment based on CCC. In a second pass, each of the 10-minute segments other than the initial anchor profile is extracted from the merged segments, realigned with the remaining merged segments based on CPSD, and re-merged into the merged segments to produce the merged 3D fingerprint of the reference device. The merged 3D reference fingerprint may then be further smoothed with ensemble averaging in a moving window, and then resampled to have values spaced at a consistent interval.

### —Example Merged Reference Fingerprint Method—ML Model Training—

At process block 225, merged reference fingerprint method 200 trains a machine learning model to detect anomalous departures from the known state of degradation (such as the known undegraded state) based on the merged reference fingerprint. For example, the merged reference fingerprint is used to configure a machine learning model to detect when a field device is operating in a degraded, incorrect, or otherwise anomalous manner.

In one embodiment, the time series signals in the merged reference fingerprint are assigned to input variables of the machine learning model. The machine learning model accepts vectors from the merged reference fingerprint as input values in an automatic training operation. The automatic training operation adjusts a configuration of the machine learning model to cause the machine learning model to produce estimates consistent with the values in the merged reference fingerprint. The training causes the machine learning model to produce estimates of what a value for each time series signal is expected to be based on actual values for other time series signals. Accordingly, the trained machine learning model may be employed as a digital twin that provides reference measurements for comparison with measurements of field devices. Differences or residuals between the estimated reference measurements and actual measurements from the field twin may be provided to a detection model such as SPRT. The detection model may then determine whether deviations from expected measurement values indicate that operations of the field twin are degraded or otherwise anomalous. Additional detail on training of the machine learning model to detect an anomaly is provided below under the heading “Overview of Multivariate ML Anomaly Detection”. In one embodiment, the training of the machine learning model at process block 225 is performed by ML model trainer 120.

In one embodiment, the trained machine learning model resulting from merged reference fingerprint method is a highly accurate characterization of operation of the golden system (reference device). The machine learning model was trained on a merged reference fingerprint, in which noise is cancelled and signal reinforced through a process of alignment and merging of measurements for repeated test cycles of the golden system. In one embodiment, training with the merged reference fingerprint causes the machine learning model to exhibit improved prognostic accuracy as a digital twin of field assets. For example, training with the merged reference fingerprint causes the machine learning model to generate fewer false alarm probabilities (FAPs) and fewer missed alarm probabilities (MAPs) than an ML model trained with the same repeated iterations that are left un-merged.

### —Various Embodiments of Merged Reference Fingerprint Method—

In one embodiment, aligning and merging the segments (as discussed at process block 220 above) includes an initial coarse alignment and merge followed by a fine re-alignment and re-merging of the segments. In one embodiment, merged reference fingerprint method 200 coarsely aligns the segments to generate a coarse reference fingerprint. The coarse reference fingerprint is a merge of the coarsely aligned segments. And, merged reference fingerprint method 200 finely realigns the segments to generate the merged reference fingerprint. The merged reference fingerprint is a merge of the finely realigned segments.

In one embodiment, coarsely aligning the segments to generate the coarse reference fingerprint (as discussed at process block 220 above) includes steps for aligning and merging based on cross correlation coefficients or correlograms. In one embodiment, merged reference fingerprint method 200 selects one segment from the segments to be an anchor segment. Then, merged reference fingerprint method 200 aligns an additional segment of the segments to the anchor segment. The alignment is based on a cross correlation coefficient between the anchor segment and the additional segment. Then merged reference fingerprint method 200 merges the aligned additional segment with the anchor segment. The aligning and merging steps are repeated for each additional segment of the segments. Merged reference fingerprint method 200 then provides the anchor segment merged with the aligned additional segments as the coarse reference fingerprint.

In one embodiment, finely aligning the segments to generate the merged reference fingerprint (as discussed at process block 220 above) includes steps for realigning the merged segments to increase alignment based on cross power spectral density or phase angle. In one embodiment, merged reference fingerprint method 200 extracts one segment from the coarse reference fingerprint. Merged reference fingerprint method 200 then realigns the one segment to the coarse reference fingerprint with the one segment removed. The realignment is based on a cross power spectral density between the one segment and the coarse reference fingerprint with the one segment removed. The realignment increases alignment between the one segment and the coarse reference fingerprint with the one segment removed. Merged reference fingerprint method 200 then merges the realigned one segment back into the coarse reference fingerprint. The extracting, realigning and merging steps are repeated for each of the segments in the coarse reference fingerprint. Merged reference fingerprint method 200 then provides the coarse reference fingerprint with the segments realigned as the merged reference fingerprint.

Thus, in one embodiment, aligning and merging the segments (as discussed at process block 220 above) is performed in two passes: aligning the segments in a first pass and refining the alignment of the segments in a second pass. In one embodiment, in the first pass, merged reference fingerprint method 200 aligns the segments based on cross correlation coefficients between the segments to generate an initial reference fingerprint. The initial reference fingerprint is a merge of the aligned segments. And, in the second pass, merged reference fingerprint method 200 realigns the segments based on cross power spectral density between individual segments extracted from the initial reference fingerprint and the initial reference fingerprint to generate the merged reference fingerprint. The merged reference fingerprint is a merge of the realigned segments.

In one embodiment, before training the machine learning model (at process block 225), merged reference fingerprint method 200 smooths the merged reference fingerprint by ensemble averaging and ensures a consistent pace of sampling in the merged reference fingerprint by resampling. Thus, in one embodiment, merged reference fingerprint method 200 ensemble averages the merged reference fingerprint in a moving window. Then, merged reference fingerprint method 200 resamples the ensemble-averaged merged reference fingerprint at a uniform interval of time.

In one embodiment, generating the set of time series signals (at process block 210) includes a data transformation to convert high-frequency waveforms into lower sampling rate clusters of time series. In one embodiment, merged reference fingerprint method 200 accepts the sensor readings of the reference device. The sensor readings are sampled at a first (high) sampling rate. For example, the sensor readings are vibration data, acoustic data, ultrasonic data, electromagnetic interference data, or infrared thermal imaging data sampled at a high frequency, also referred to as high-frequency data. Then, merged reference fingerprint method 200 divides a frequency spectrum of the sensor readings into a plurality of frequency bins. Merged reference fingerprint method 200 proceeds to sample the frequency bins at a second (lower) sampling rate to produce the set of time series signals. The time series signals in the set of time series signals correspond to the frequency bins. The second sampling rate is lower than the first sampling rate.

In one embodiment, the operation of the reference device (discussed at process block 210) includes rest periods between the individual iterations of the exercise profile. The rest periods provide stubs of flat noisy values at ends of the segments for the individual performances.

In one embodiment, after the machine learning model is trained (at process block 225), the trained machine learning model is used to detect whether field twins of the reference device (field devices) are operating in a degraded manner. In one embodiment, merged reference fingerprint method 200 monitors a field device with the trained machine learning model to detect an anomaly indicating degraded operation of the field device. In response to detecting the anomaly, merged reference fingerprint method 200 generates an electronic alert that the field device exhibits the degraded operation. Additional detail on monitoring time series signals for anomalies is provided below under the heading “Overview of Multivariate ML Anomaly Detection”, and additional detail regarding the generation of an electronic alert is described herein under the heading “Electronic Alerts”.

In one embodiment (following the training of the machine learning model at process block 225), the trained machine learning model monitors time series signals that represent the operation of a field twin of the reference device. (The field twin may also be referred to herein as a field device). The time series signals are converted from high-frequency waveforms of sensor readings into lower sampling rate clusters of time series signals for example as described above with reference to generating the set of time series signals. In one embodiment, merged reference fingerprint method 200 accepts field sensor readings of a field device. The field sensor readings are sampled at a first (high frequency) sampling rate. Merged reference fingerprint method 200 then converts the field sensor readings to a field set of time series signals. The field set of time series signals have a second sampling rate that is lower than the first sampling rate. Merged reference fingerprint method 200 then transmits the field set of time series signals to the trained machine learning model. In one embodiment, the conversion to the second sampling rate reduces transmission bandwidth for the field sensor readings. Then, merged reference fingerprint method 200 monitors the field set of time series signals with the trained machine learning model to detect an anomaly indicating degraded operation of the field device. In response to detecting the anomaly, merged reference fingerprint method 200 generates an electronic alert that the field device exhibits the degraded operation.

In one embodiment, the merged reference fingerprint method 200 includes cycling a motor of the reference device through a range of speeds a plurality of times over a time period to operate the reference device through the exercise profile. And, the merged reference fingerprint method 200 then generates a three-dimensional vibration fingerprint characterizing the motor. The set of time series readings is the three-dimensional vibration fingerprint.

### DISCUSSION AND ADDITIONAL EMBODIMENTS

Digital twins (DTs) for prognostics of complex engineering assets are becoming widespread. However, the DT framework is very challenging to extend to assets that are monitored by high sampling rate transducers that create high-frequency waveforms because of input/output bandwidth constraints on streaming real time waveforms directly into cloud or other rapid computing systems that perform the DT prognostics. In one embodiment, the merged reference fingerprint techniques described herein overcome the bandwidth constraints and allows extension of DT prognostic frameworks to include assets monitored by high sampling rate waveforms. The high sampling rate waveforms may include data such as vibrations (KHz waveforms), acoustics and ultrasonics (MHz waveforms), electromagnetic interference (EMI) and infrared (IR) Thermal-Imaging (GHz waveforms). And, in one embodiment, the merged reference fingerprint techniques described herein introduce a novel “Merged Surface 3D Fingerprint” of reference (golden) devices that improves accuracy and speed for diagnostic scans of digital twin assets in the field.

For some DT approaches, a “Golden System” or reference device will be built for an asset. The asset may be, for example, a motor, or car engine, electric utility transformer, manufacturing equipment used in manufacturing facilities, or a wide variety of other devices. The Golden System is an asset that is free of aging defects or any known degradation modes. Then, there may be any number of “Field Twins” or field devices. The Field Twins are assets of a similar or same make/model as the Golden System. Sensor telemetry readings from whatever sensors exist in the Field Twins are collected and compared with readings from the corresponding sensors in the Golden System (GS). Discrepancies in signals between the GS and any of the Field Twins indicate there may be degradation in the Field Twin, so a flag or other alert is sent to services engineers or other personnel responsible for maintenance of the Field Twin.

In one use of DT for prognostics, instead of comparing the telemetry from the Field Twin to a physical GS asset operating in a laboratory setting, DT may use a Machine Learning (ML) model of the GS asset for comparison. The ML model is trained from signals from the GS asset. Use of the ML model for prognostics improves over the use of a physical GS asset for a number of reasons. Because the ML model does not degrade over time, the ML model of the GS will not be subject to gradual degradation as may the physical GS. Further, during training of the ML model (or collecting of data to train the ML model), the GS asset may be operated through its full performance range, and under all possible (or reasonably anticipated) conditions of ambient “background” variables that could possibly affect asset performance (such as ambient temperature, relative humidity, barometric pressure, external vibration levels, etc.). Using an ML-model as GS therefore readily adapts to the ambient conditions of deployed Field Twins, making the DT framework much more robust to the ambient conditions that can cause false anomaly alarms. For example, a major cause of false anomaly alarms occurs when a Field Twin asset has very different ambient conditions versus a physical GS asset in the lab.

The merged reference fingerprint techniques shown and described herein significantly improves the technology of digital twinning, for example, by extending DT prognostics in two significant ways (A) capturing high-sampling rate data in a lower sampling rate format, and (B) increased prognostic accuracy and rapidity of anomaly scanning using merged references from the GS, as discussed below. In one embodiment, these significant new capabilities made possible by the present “Merged Surface 3D Fingerprint”.

Regarding item (A), there are ultrahigh-frequency transducers that create very high sampling rate waveforms that are not amenable to sending to any Cloud for prognostic analyses because of bandwidth limitations. Examples of sensors that generate high sampling rate information include Vibration, Acoustics, EMI, and IR Thermal-Imaging transducers. These sensors are used for prognostic surveillance of assets. In one embodiment, merged reference fingerprint techniques shown and described herein use a novel data-transformation framework that converts high-frequency waveforms into lower sampling rate clusters of time series as discussed in detail elsewhere herein. This makes possible the creation of a three-dimensional (3D) fingerprint for devices such as the Golden System or Field Twins. In one embodiment, the 3D fingerprint records sensed amplitudes at a given set of frequencies over time, producing a cluster of time series with a time series of amplitude values for each of the frequencies. In a digital twin framework, the 3D fingerprint for a GS may be compared with the 3D Fingerprint for any number of Field Twins. The comparison may be performed totally in a cloud due to the lower sampling rates for the cluster of time series signals.

Regarding item (B), In one embodiment, merged reference fingerprint techniques shown and described herein introduce a new “Merged Surface 3D Fingerprint” for the GS fingerprint. The merged surface 3D fingerprint synchronizes and merges multiple scan iterations, producing a composite, highly accurate characterization of scanned asset. For Field Twin assets, there is a desire to keep the “scan time” minimal, because there can be very many field assets, and because humans are most often involved with conducting the scans. In one embodiment, 3 minutes is a comfortable scan time. For example, a scan may be conducted while cycling a motor from min to max several times over a 3-minute period to create a 3D fingerprint of the vibrations characterizing the motor. But for the GS Asset, the 3D Fingerprint is created one time, off-line. In one embodiment, “off-line” creation of the GS fingerprint indicates that the GS asset is in a laboratory setting for the purposes of being scanned to create a GS or reference fingerprint, in contrast to the asset being operated in a real-time production mode. This means that more time can be taken to perform a sequence of replicated scans. The readings resulting from sequence of multiple scans may then be merged or stacked together to produce an improved, higher resolution composite or merged 3D fingerprint for the golden system. The readings for the multiple scans may be merged in a two-pass coarse alignment and fine realignment process, as discussed in more detail elsewhere herein. The merged 3D fingerprint enables scans for the Field Twins to be performed more quickly, and with improved avoidance of false alarms and missed alarms (due to the increased resolution and reduced noise offered by the merged 3D fingerprint) in the overall Digital Twin Prognostic Framework.

In one embodiment, merged reference fingerprint techniques shown and described herein introduce a new Digital Twin framework that allows ultrahigh frequency (UHF) transducer waveforms (for example Vibration, Acoustics, EMI, and IR_Thermal-Imaging) with a novel frequency-domain to time-domain transformation to a 3D fingerprint that allows the DT framework to be implemented in a cloud setting. In one embodiment, without data transformation into the 3D fingerprint, bandwidth constraints might otherwise rule out cloud implementation of DT prognostics involving UHF transducers. And, and a novel merged surface 3D fingerprint for the Golden System asset improves the prognostic accuracy and rapidity of Field Twin scans.

In one embodiment, the merged reference fingerprint techniques shown and described herein improves the technology of prognostic analysis by offering higher sensitivity for detection of anomalous performance in assets that may be monitored with embedded or attached ultrahigh frequency (UHF) transducers. In one embodiment, the merged reference fingerprint techniques improves the technology of prognostic analysis by enabling digital twin monitoring of ultrahigh frequency (UHF) signals in a cloud environment. In one embodiment, the merged reference fingerprint techniques improves the technology of prognostic analysis by reducing both false-alarm and missed-alarm probabilities (Type-I and Type-II misidentification probabilities) in anomaly detection. Fast scanning is useful where human technicians manually initiate manual scans of field assets that are to be compared with Golden System scans, for example in a Digital Twin framework. In one embodiment, the merged reference fingerprint techniques improves the technology of prognostic analysis by offering a highly accurate merged surface 3D fingerprint for Golden Systems attained by a dual-pass data flow. In one embodiment, the merged reference fingerprint techniques improves the technology of prognostic analysis by increasing the speed of the scanning procedure, resulting in shorter scan times for the field assets (for example, reducing the time for a scan to nominally 3 minutes) due to higher-accuracy GS fingerprints. Thus, the merged reference fingerprint techniques shown and described herein allows existing digital twin prognostic frameworks to be more accurate and have less false-alarm rates for ML prognostic anomaly discovery.

In one embodiment, for 3D Golden System Digital Twin “Fingerprints” the basic concept is to run a deterministic dynamic load profile on an asset while performing a scan of the asset. For example, the scanner may be an embedded or magnetic-mounted (called “mag-mount) accelerometer (vibration sensor), microphone, accelerometer, IR-thermal imager, or other sensor. The deterministic dynamic load profile operates the asset through a pre-established pattern of changes in load, for example a repeating pattern. The scanner produces sensor readings of the asset resulting from the deterministic load placed on the asset. The sensor readings may then be used to create a 3D binned-frequency pattern or fingerprint for the asset. The 3D fingerprint may be taken from a reference or golden system asset, or from a field twin or test system asset. The 3D fingerprints may be used to compare any number of twin assets in the field with a golden system for high-sensitivity prognostics of all types of incipient degradation modes for the assets in the field.

In one embodiment, it may be desirable to keep the scan time under N minutes. In one embodiment, N=10 minutes yields satisfactory results in laboratory experimentation, as does N=5 minutes. With a scan of N minutes for a test system in the field, the accuracy of the 3D fingerprint is a function of the scanning and analysis hardware. Scanning and analysis using large and/or expensive laboratory-grade systems can achieve very high accuracy. But it is desirable to achieve high accuracy with compact and/or inexpensive scanning instrumentation. For a scan time of N minutes, the accuracy of the 3D fingerprint for the test system is adequately high. For example, stated quantitatively, noise levels on top of the deterministic base signal (in individual frequency bins) have a standard deviation (STD) lower than 2%, which is adequate.

For the golden system 3D fingerprint scan, conducting an N-min scan yields approximately the same uncertainty level. However, using the merged reference fingerprint techniques shown and described herein a substantially more accurate 3D fingerprint may be produced for the golden system. In one embodiment, the improved accuracy due to the merged reference fingerprint techniques are achieved even with exactly the same instrumentation and analysis hardware. In one embodiment, as an overview, instead of performing the scan for N minutes, the scan is conducted for a much longer time to create a long and repetitive fingerprint.

As a simple example, where N=10 for a desired 10-minute 3D fingerprint scan time, the scan may be performed on the golden system for slightly over an hour while the dynamic profile is repeated with a short sleep or rest time between each repeat of the basic dynamic profile. This creates, in effect, six replications of the basic dynamic profile in a long contiguous binned-frequency 3D signature, with short breaks of flat noise from the sleep time between the six replicated dynamic profiles. (This example is also discussed above with reference to method 200). More or fewer replications may also be acceptable, but experimentation has found six repetitions of the scan to yield satisfactorily accurate merged fingerprints.

The long, approximately 1-hour scan is then subdivided or “cut up” into six segments or “chunks,” each of which is approximately 10 minutes, with a short stub of flat noise on each end of the segments. In one embodiment, the divisions or cuts are made within the flat noise between the dynamic profiles. In one embodiment, the segments cover a complete iteration of the dynamic profile placed on the golden system. The short stubs permit flexibility for lead-lag adjustments for alignment of the segments. In one embodiment, the segments are then aligned and merged in two passes: a first pass for coarse alignment, and then a second pass for fine realignment.

In a first step (step one), the first complete dynamic load profile (segment) is picked as the reference exercise profile. In one example, where N=10 min, this first anchor or reference profile is slightly greater than 10 min, with short stubs on each end that will get trimmed off after merging. In one embodiment, this anchor or reference exercise profile establishes a reference time sequence that will be immutable and unchanging throughout the remaining sequence of operations through two iteration the first and second passes to create a merged reference 3D fingerprint of the golden system.

In a second step (step two), the second complete dynamic load profile (segment) is picked. The segment is then slid forward or backward to optimize fit, for example by maximizing cross correlation, with the reference exercise profile. Merge this second segment with the reference exercise profile to generate an improved reference exerciser profile. In one embodiment, the two segments are slid back and forth to hit the maximum cross correlation by systematically incrementing a lead/lag delta by a small increment, computing a cross correlation coefficient, and selecting the delta that results in the maximum cross correlation coefficient. In one embodiment, the increment is a one-second increment. In one embodiment, the cross-correlation coefficient is a Pearson cross correlation coefficient. The cross-correlation coefficient is calculated for each delta increment, and then the optimum delta-time that produces the max CCC is selected.

Alignment between segments based on cross correlation results in a good approximation in a first alignment pass. Alignment between segments will be improved in a second pass with a more accurate but more compute-costly algorithm, such a cross power spectral density analysis.

In a third step (step three), steps one and two above are repeated for the subsequent segments, each time merging the resulting aligned segment with the reference exerciser profile and updating it. For example, each time through this first iterative loop (for example as discussed with reference to method 300 and FIG. 3 below), the reference exercise profile gets more and more accurate. Note that if the six chunks were simply “cut and pasted”, the accuracy of the 3D fingerprint would not necessarily increase at all, because any asynchronies in the deterministic load profiles for the separate chunks would create destructive interference in the merged 3D fingerprint. By contrast, it is by the new analytical procedure (for merged reference fingerprinting) shown and described herein that successively enhances the synchrony of the dynamic profiles that constructive amplification (vs. destructive interference) of the deterministic structure in the profile is assured. In one embodiment, the improvement in accuracy derives at least in part from noise cancellation for the noise superimposed on (or riding on top of) the deterministic dynamic profile. As random noise is equally likely to be above as below the mean, when 2, 3, . . . . N replicated measurements of random noise are merged together, the positive and negative noise components cancel. Thus, the noise components above and below the deterministic line traced by the exercise profile are cancelled by the aligned merge. The exercise profile itself is not canceled by the merge because the waveforms of individual iterations of the exercise profile are aligned. The standard deviation of the merged replicate segments decreases with the square root of the number N of replicated measurements. Thus, in one embodiment, the merged reference fingerprint techniques taught herein have the overall benefit of enhancing the constructive amplification of the dynamic (signal) components with attenuation (by 1/SQRT (N)) of the noise components.

In a fourth step (step four), once all the N available segments are synchronized through the initial approximate CCC optimization approach and merged, a second pass through all the segments is performed starting with the first segment. In the second pass, before optimizing for a selected segment, the data generated from the selected segment is removed from the reference exerciser profile. After optimizing and realigning, the segment is merged back into the reference exerciser profile, but now with a more accurate synchronization technique called the cross power spectral density (CPSD). (Additional detail on the CPSD is discussed below, with reference to FIG. 4 and method 400 for the second pass alignment optimization). In one embodiment, this second pass is done so that the effects of any abnormalities or artifacts (for example from stray ambient EMI signals during the scan process) that may have been present in the earliest segments during the first pass alignments with CCC are minimized.

In a fifth step (step five), the final reference exerciser profile is taken and the timestamps are converted in all merged segments to times (in seconds) relative to the beginning of the segment.

In a sixth step (step six), to smooth out the data, a moving-window ensemble average function is applied. In one embodiment, the moving window has a width of 20 samples.

In a seventh step (step seven), the data from step six is taken, and iterative up-sampling of the data is performed. In one embodiment, the up-sampling makes the time intervals exactly uniform. In one embodiment, step six produces densified sampling, although the sampling intervals are not necessarily uniform. The up-sampling of step seven maintains the high accuracy from step six but transforms the sampling intervals to be exactly equal. In one embodiment the sampling intervals are set to one time unit. In one embodiment, the sampling intervals are 1-second in the “reduction-to-practice” demonstration presented.

In an eighth step (step eight), Step 8: on completion of both passes of merging, the resulting data is the final merged surface high accuracy golden system fingerprint.

### —First Pass, Coarse Alignment Method—

FIG. 3 illustrates one embodiment of a first pass, coarse alignment method 300 to coarsely align the segments of a 3D fingerprint. In one embodiment, coarse alignment method 300 initiates at START block 305 in response to the 1-hour scan being subdivided into segments, and proceeds to process block 310. At process block 310, coarse alignment method 300 extracts profile (segment) 1 from the replicated profile measurements and establish it as an anchor profile. At process block 315, coarse alignment method 300 initializes a counter i of profiles (segments), and determines or sets the total number N of profiles to extract from replicated profile measurements. Decision block 320 initiates a loop for lining up and merging the discrete segments of the scan (profile measurements). The loop repeats for each remaining profile measurement other than the anchor profile (until i=N). While profile measurements remain (i>N: FALSE) to be merged into the anchor profile, the loop proceeds to process block 325. At process block 325, coarse alignment method 300 aligns and merges a current profile i into the anchor profile based on a correlogram (cross correlation coefficient) alignment. The coarse alignment adjusts lead or lag time for the current profile i to maximize the cross correlation coefficient of the current profile i with the anchor profile (and if applicable, profiled previously merged with the anchor profile). The current profile is then incremented to the next profile (i++), and the loop repeats. Once there are no further profile measurements (i>N: TRUE) to merge into the anchor profile, the loop terminates and proceeds to the second pass 330 for a fine realignment process. In one embodiment, coarse alignment method 300 is performed by coarse aligner 160.

FIG. 4 illustrates a 3D plot 400 of an example 3D fingerprint scan 405 of a golden system. Example 3D fingerprint scan 405 is plotted against a time axis 410, a power/frequency axis 415 (that is, an amplitude axis), and a frequency axis 420. Example 3D fingerprint scan 405 includes six repetitions 425 of the dynamic profile. The six repetitions 425 of the dynamic profile have brief sleep periods 430 between them. As discussed above, the six repetitions 425 may be separated into segments in the sleep periods 430.

FIG. 5 illustrates a 3D plot 500 of an example coarse merge 505 of the six repetitions 425. Example coarse merge 505 is plotted against a time axis 510, a power/frequency axis 515 (that is, an amplitude axis), and a frequency axis 520. In one embodiment, example coarse merge 505 shows a final round of pass 1 where all 6 scans have been aligned and merged using the cross-correlation coefficient (CCC) technique. The merged surface from pass 1 has significantly lower noise content than any of the original segments. The reduction of noise can be seen from the significantly decreased spikiness of the example coarse merge 505 in comparison with example 3D fingerprint scan 405. Reduction of noise content is one objective of using CCC for approximate alignment and merging for pass 1. Experimentation has shown that this first pass, CCC-based merging process reduces the random noise by an average of 78% following the initial Pass 1 (for six aligned and merged segments).

### —Second Pass, Fine Re-Alignment Method—

FIG. 6 illustrates one embodiment of a second pass, fine realignment method 600. In one embodiment, fine realignment method 600 continues from the first pass, coarse alignment method 300 at block 605 in response to the completion of coarse alignment method 300, and proceeds to process block 610. At process block 610, fine realignment method initializes a counter i of profiles (segments) for the second pass, and again determines or sets the total number N of profiles to extract from the replicated—and now merged-profile measurements. Decision block 615 initiates a loop for fine tuning the alignments of the merged profiles in order to increase their overall alignment. The loop repeats for each remaining profile measurement other than the anchor profile (until i=N). While profile measurements remain (i>N: FALSE) remain to be fine-tuned or realigned, the loop proceeds to process block 620.

At process block 620, fine realignment method 600 removes data generated by the profile i from the merged anchor profile. In other words, profile or segment i as previously adjusted (in pass 1) for lead or lag time is extracted or separated back out from the merged profile, while profiles other than profile i remain in the merged profile. At process block 620, fine realignment method 600 uses a phase angle determined through cross power spectral density (CPSD) computation to align and re-merge profile i into the anchor profile more precisely. In other words, the adjustment for lead or lag time of segment i is fine-tuned to minimize a phase angle difference between the extracted segment i and the merged collection of segments other than segment i. Once the phase angle difference is minimized by an adjustment to the lead or lag time of segment i, segment i is re-merged into the merged anchor profile with the adjusted lead or lag time. The current profile is then incremented to the next profile (i++), and the loop repeats. Once there are no further profile measurements (i>N: TRUE) to merge into the anchor profile, the loop terminates and proceeds to END block 630 where fine realignment method 600 concludes.

In the second pass, fine realignment process, the merged reference profile that resulted from the first pass (discussed above) is used to become the new anchor profile. From this merged reference profile, original surfaces 1 through N are successively removed or subtracted out, and a phase angle determined through a CPSD computation is used to more precisely align each removed profile with the profiles remaining in the merged reference profile. Once the removed profile is more precisely aligned, it is re-merged with the adjusted alignment back into the reference profile. Experimentation has shown that this further CPSD-based fine realignment further reduces the remaining noise by an additional 11% on average (for six merged and realigned segments).

In one embodiment, the second pass performs a realignment of the segments using a cross power spectral density technique. The cross power spectral density technique is a bivariate frequency-domain technique that uses a bivariate fast Fourier transform (FFT) computation that infers the phase angle between two timeseries in the frequency domain. The CPSD algorithm is employed to compute an optimal fine grain estimate of the lag time from the phase angle. Pairwise computations are performed for all binned frequency time-series signals in the collection, adjusting signals to bring the empirical lag times to zero. This novel dual pass iterative approach leverages the approximate (but light-weight) CCC technique in the first pass, then systematically takes out each segment, one at a time, from the reference dynamic profile, and puts it back in with the much more accurate (but more compute-costly) CPSD technique in the second pass. In one embodiment, fine realignment method 600 is performed by fine re-aligner 165.

In one embodiment, the overall outcome is a very highly accurate golden system 3D fingerprint. This 3D fingerprint of the golden or reference system may then be used to perform rapid scans of test systems. The overall scan time for initial creation of the golden system 3D fingerprint may be greater than the target of N minutes for fast scans. But, the longer scan time for this step does not matter because the golden system 3D fingerprint is performed off-line and once. The test system scans are then conducted many times on the twin assets. The increased accuracy of the golden system fingerprint allows conclusions to be drawn in a scan of a twin asset more rapidly, and with increased prognostic accuracy than would be available using a non-merged golden fingerprint. Hence, while it can be important to minimize the scan time for the “twin assets,” the increased scan time for the golden system scan matters little and is recouped many times over by the reduced scan time it makes available for the twin assets.

In one embodiment, the first pass, cross-correlation-coefficient-based alignment technique is performed before the higher-accuracy, higher resolution cross-power-spectral-density-based alignment technique so as to provide an initial baseline alignment. Were the alignment process to simply start out with the higher-resolution CPSD technique described for the second pass without initially performing the CCC technique described for the first pass, the result would be poor because the CPSD technique would be comparing noisy individual profiles (segments) with other noisy individual profiles. Instead, with the innovative 2-pass process merged fingerprint process, during the second pass the high-resolution CPSD comparison is performed based on a much more accurate, far less noisy merged reference profile generated in the first pass.

### —Overview of Multivariate ML Anomaly Detection—

In general, multivariate ML modeling techniques used for ML anomaly detection predict or estimate what each signal should be or is expected to be based on the other signals in a database or collection of time series signals. The predicted signal may be referred to as the “estimate”. A multivariate ML anomaly detection model is used to make the predictions or estimates for individual variables based on the values provided for other variables. For example, for Signal 1 in a database of N signals, the multivariate ML anomaly detection model will generate an estimate for Signal 1 using signals 2 through N.

In one embodiment, the ML anomaly detection model may be a non-linear non-parametric (NLNP) regression algorithm used for multivariate anomaly detection. Such NLNP regression algorithms include auto-associative kernel regression (AAKR), and similarity-based modeling (SBM) such as the multivariate state estimation technique (MSET) (including Oracle's proprietary Multivariate State Estimation Technique (MSET2)). In one embodiment, MSET (and other NLNP algorithms advantageously parallelize naturally (at the thread level) on graphics processing unit (GPU) processors. In one embodiment, the ML anomaly detection model may be another form of algorithm used for multivariate anomaly detection, such as a neural network (NN), Support Vector Machine (SVM), or Linear Regression (LR). Note that NN and SVMs operate based on stochastic optimization of weights, and therefore do not allow for thread-level parallelism.

The ML anomaly detection model is trained to produce estimates of what the values of variables should be based on training with exemplar vectors that are designated to represent expected, normal, or correct operation of a monitored asset. To train the ML anomaly detection model, the exemplar vectors are used to adjust the ML anomaly detection model. A configuration of correlation patterns between the variables of the ML anomaly detection model is automatically adjusted based on values for variables in the exemplar vectors. The adjustment process continues until the ML anomaly detection model produces accurate estimates for each variable based on inputs to other variables. Sufficient accuracy of estimates to conclude determine the ML anomaly detection model to be sufficiently trained may be determined by residuals—a residual is a difference between an actual value (such as a measured, observed, sampled, or resampled value) and an estimate, reference, or prediction of what the value is expected to be—being minimized below a pre-configured training threshold. At the completion of training, the ML anomaly detection model has learned correlation patterns between variables.

Following training, the ML anomaly detection model may be used to monitor time series signals. Subtracting an actual, measured value for each signal from a corresponding estimate gives the residuals or differences between the values of the signal and estimate. Where there is an anomaly in a signal, the measured signal value departs from the estimated signal value. This causes the residuals to increase, triggering an anomaly alarm. Thus, the residuals are used to detect such anomalies where one or more of the residuals indicates such a departure, for example by becoming consistently excessively large.

For example, the presence of an anomaly may be detected by a sequential probability ratio test (SPRT) analysis of the residuals, as discussed in detail above. In one embodiment, the SPRT calculates a cumulative sum of the log-likelihood ratio for each successive residual between an actual value for a signal and an estimated value for the signal, and compares the cumulative sum against a threshold value indicating anomalous deviation. Where the threshold is crossed, an anomaly is detected, and an alert indicating the anomaly may be generated.

### —Electronic Alerts—

In one embodiment, an electronic alert is generated by composing and transmitting a computer-readable message. The computer readable message may include content describing the anomaly that triggered the alert, such as a time or time stamp for when the anomaly was detected, an indication of the signal value that caused the anomaly, an identification of a source of the signal (such as an asset, component, or sensor) for which the anomaly occurred and the alert is applicable. In one embodiment, an electronic alert may be generated and sent in response to a detection of an anomalous signal value. The electronic alert may be composed and then transmitted for subsequent presentation on a display or other action.

In one embodiment, the electronic alert is a message that is configured to be transmitted over a network, such as a wired network, a cellular telephone network, wi-fi network, or other communications infrastructure. The electronic alert may be configured to be read by a computing device. The electronic alert may be configured as a request (such as a REST request) used to trigger initiation of a function in response to detection of an anomaly, such as triggering a maintenance response for an asset monitored by the anomalous signal. In one embodiment, the electronic alert may be presented in a user interface such as a graphical user interface (GUI) by extracting the content of the electronic alert by a REST API that has received the electronic alert. The GUI may present a message, notice, or other indication that the monitored asset has entered (or left) an anomalous state of operation.

### —Cloud or Enterprise Embodiments—

In one embodiment, the present system (such as merged reference fingerprint system 100) is a computing/data processing system including a computing application or collection of distributed computing applications for access and use by other client computing devices that communicate with the present system over a network. In one embodiment, merged reference fingerprint system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, merged reference fingerprint system 100 is a centralized server-side application that provides at least the functions disclosed herein and that is accessed by many users by way of computing devices/terminals communicating with the computers of merged reference fingerprint system 100 (functioning as one or more servers) over a computer network. In one embodiment merged reference fingerprint system 100 may be implemented by a server or other computing device configured with hardware and software to implement the functions and features described herein.

In one embodiment, the components of merged reference fingerprint system 100 may be implemented as sets of one or more software modules executed by one or more computing devices specially configured for such execution. In one embodiment, the components of merged reference fingerprint system 100 are implemented on one or more hardware computing devices or hosts interconnected by a data network. For example, the components of i merged reference fingerprint system 100 may be executed by network-connected computing devices of one or more computer hardware shapes, such as central processing unit (CPU) or general-purpose shapes, dense input/output (I/O) shapes, graphics processing unit (GPU) shapes, and high-performance computing (HPC) shapes.

In one embodiment, the components of merged reference fingerprint system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of merged reference fingerprint system 100 may (i) generate or compose an electronic message or signal to issue a command or request to another component, (ii) transmit the message or signal to other components of merged reference fingerprint system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by merged reference fingerprint system 100, for example through a web interface server. In one embodiment, the remote computing system may send requests to and receive responses from merged reference fingerprint system 100. In one example, access to the information or applications may be effected through use of a web browser on a personal computer or mobile device. In one example, communications exchanged with merged reference fingerprint system 100 may take the form of remote representational state transfer (REST) requests using JavaScript object notation (JSON) as the data interchange format for example, or simple object access protocol (SOAP) requests to and from XML servers. The REST or SOAP requests may include API calls to components of merged reference fingerprint system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

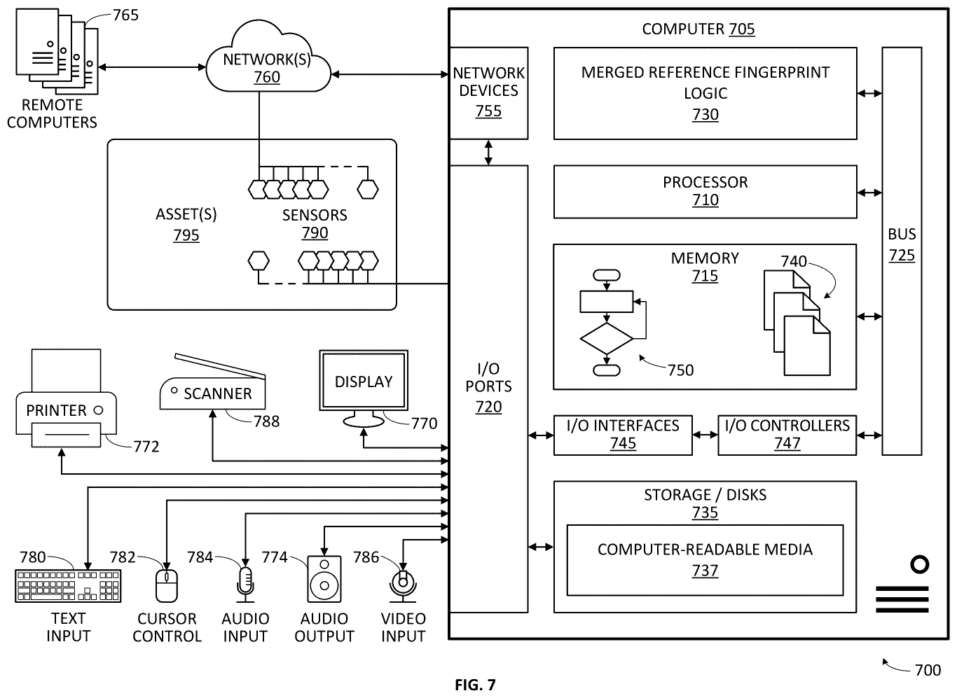

FIG. 7 illustrates an example computing system 700. Example computing system 700 includes an example computing device that is configured and/or programmed as a special purpose computing device with one or more of the example systems and methods described herein, and/or equivalents. The example computing device may be a computer 705 that includes at least one hardware processor 710, a memory 715, and input/output ports 720 operably connected by a bus 725. In one example, the computer 705 may include merged reference fingerprint logic 730 configured to facilitate a digital twin merged-surface 3D fingerprint technique for improved prognostics for assets, similar to logic, systems, methods, and other embodiments shown in and described with reference to FIGS. 1, 2, 3, 4, 5, and 6.

In different examples, the logic 730 may be implemented in hardware, a non-transitory computer-readable medium 737 with stored instructions, firmware, and/or combinations thereof. While the logic 730 is illustrated as a hardware component attached to the bus 725, it is to be appreciated that in other embodiments, the logic 730 could be implemented in the processor 710, stored in memory 715, or stored in disk 735.

In one embodiment, logic 730 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to a digital twin merged-surface 3D fingerprint technique for improved prognostics for assets. The means may also be implemented as stored computer executable instructions that are presented to computer 705 as data 740 that are temporarily stored in memory 715 and then executed by processor 710.

Logic 730 may also provide means (e.g., hardware, non-transitory computer-readable medium that stores executable instructions, firmware) for performing one or more of the disclosed functions and/or combinations of the functions.

Generally describing an example configuration of the computer 705, the processor 710 may be a variety of various processors including dual microprocessor and other multi-processor architectures. A memory 715 may include volatile memory and/or non-volatile memory. Non-volatile memory may include, for example, ROM, PROM, and so on. Volatile memory may include, for example, RAM, SRAM, DRAM, and so on.

A storage disk 735 may be operably connected to the computer 705 via, for example, an input/output (I/O) interface (e.g., card, device) 745 and an input/output port 720 that are controlled by at least an input/output (I/O) controller 747. The disk 735 may be, for example, a magnetic disk drive, a solid-state disk drive, a floppy disk drive, a tape drive, a Zip drive, a flash memory card, a memory stick, and so on. Furthermore, the disk 735 may be a CD-ROM drive, a CD-R drive, a CD-RW drive, a DVD ROM, and so on. The memory 715 can store a process 750 and/or a data 740, for example. The disk 735 and/or the memory 715 can store an operating system that controls and allocates resources of the computer 705.

The computer 705 may interact with, control, and/or be controlled by input/output (I/O) devices via the input/output (I/O) controller 747, the I/O interfaces 745, and the input/output ports 720. Input/output devices may include, for example, one or more displays 770, printers 772 (such as inkjet, laser, or 3D printers), audio output devices 774 (such as speakers or headphones), text input devices 780 (such as keyboards), cursor control devices 782 for pointing and selection inputs (such as mice, trackballs, touch screens, joysticks, pointing sticks, electronic styluses, electronic pen tablets), audio input devices 784 (such as microphones or external audio players), video input devices 786 (such as video and still cameras, or external video players), image scanners 788, video cards (not shown), disks 735, network devices 755, and so on. The input/output ports 720 may include, for example, serial ports, parallel ports, and USB ports.

The computer 705 can operate in a network environment and thus may be connected to the network devices 755 via the I/O interfaces 745, and/or the I/O ports 720. Through the network devices 755, the computer 705 may interact with a network 760. Through the network, the computer 705 may be logically connected to remote computers 765. Networks with which the computer 705 may interact include, but are not limited to, a LAN, a WAN, and other networks.

In one embodiment, the computer may be connected to sensors 790 through I/O ports 720 or networks 760 in order to receive information about physical states of a monitored asset 795. In one embodiment, sensors 790 are configured to generate sensor readings of physical phenomena occurring in or around an asset 795. The assets generally include any type of machinery or facility with components that perform measurable activities. In one embodiment, sensors 790 may be operably connected or affixed to assets or otherwise configured to detect and monitor physical phenomena occurring in or around the asset 795. The sensors 790 may produce sensor readings of the asset 795 at high frequencies.

In one embodiment, the sensors 790 may include (but are not limited to): a temperature sensor, a vibration sensor, an ultrasonic sensor, an IR-thermal sensor, an accelerometer, a voltage sensor, a current sensor, a pressure sensor, a rotational speed sensor, a flow meter sensor, a speedometer or other speed sensor, an airspeed sensor or anemometer, a microphone, an electromagnetic radiation sensor, a proximity sensor, a gyroscope, an inclinometer, a global positioning system (GPS) sensor, a fuel gauge, a torque sensor, a flex sensor, a nuclear radiation detector, or any of a wide variety of other sensors or transducers for generating electrical signals that represent sensed physical phenomena, for example physical phenomena occurring in or around an asset.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

In general, connections between components described herein are operable connections. An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, comprising:
generating a set of time series signals from sensor readings of a reference device while the reference device is operated through multiple individual iterations of an exercise profile, wherein the reference device operates with a known state of degradation;
separating the set of time series signals into segments that correspond to the individual iterations of the exercise profile;
aligning and merging the segments to generate a merged reference fingerprint; and
training a machine learning model to detect anomalous departures from the known state of degradation based on the merged reference fingerprint.

2. The computer-implemented method of claim 1, wherein aligning and merging the segments further comprises:
coarsely aligning the segments to generate a coarse reference fingerprint, wherein the coarse reference fingerprint is a merge of the coarsely aligned segments; and
finely realigning the segments to generate the merged reference fingerprint, wherein the merged reference fingerprint is a merge of the finely realigned segments.

3. The computer-implemented method of claim 2, wherein coarsely aligning the segments to generate the coarse reference fingerprint further comprises:
selecting one segment from the segments to be an anchor segment;
align an additional segment of the segments to the anchor segment based on a cross correlation coefficient between the anchor segment and the additional segment;
merge the aligned additional segment with the anchor segment, wherein the aligning and merging are repeated for each additional segment of the segments; and
providing the anchor segment merged with the aligned additional segments as the coarse reference fingerprint.

4. The computer-implemented method of claim 2, wherein finely aligning the segments to generate the merged reference fingerprint further comprises:
extracting one segment from the coarse reference fingerprint;
realign the one segment to the coarse reference fingerprint with the one segment removed based on a cross power spectral density between the one segment and the coarse reference fingerprint with the one segment removed, wherein the realignment increases alignment between the one segment and the coarse reference fingerprint with the one segment removed;
merge the realigned one segment back into the coarse reference fingerprint, wherein the extracting, realigning, and merging are repeated for each of the segments in the coarse reference fingerprint; and
providing the coarse reference fingerprint with the segments realigned as the merged reference fingerprint.

5. The computer-implemented method of claim 1, further comprising, before training the machine learning model:
ensemble averaging the merged reference fingerprint in a moving window; and
resampling the ensemble-averaged merged reference fingerprint at a uniform interval.

6. The computer-implemented method of claim 1, wherein generating the set of time series signals further comprises:
accepting the sensor readings of the reference device, wherein the sensor readings are sampled at a first sampling rate;
divide a frequency spectrum of the sensor readings into a plurality of frequency bins; and
sample the frequency bins at a second sampling rate to produce the set of time series signals, wherein the time series signals in the set of time series signals correspond to the frequency bins, and wherein the second sampling rate is lower than the first sampling rate.

7. The computer-implemented method of claim 1, wherein the operation of the reference device includes rest periods between the individual iterations of the exercise profile, wherein the rest periods provide stubs of flat noisy values at ends of the segments for the individual performances.

8. The computer-implemented method of claim 1, further comprising:
monitoring a field device with the trained machine learning model to detect an anomaly indicating degraded operation of the field device; and
in response to detecting the anomaly, generating an electronic alert that the field device exhibits the degraded operation.

9. The computer-implemented method of claim 1, further comprising:
cycling a motor of the reference device through a range of speeds a plurality of times over a time period to operate the reference device through the exercise profile; and
generating a three-dimensional vibration fingerprint characterizing the motor, wherein the set of time series readings is the three-dimensional vibration fingerprint.

10. A non-transitory computer-readable medium that includes stored thereon computer-executable instructions that when executed by at least a processor of a computer cause the computer to:
generate a set of time series signals from sensor readings of a reference device while the reference device is operated through multiple individual iterations of an exercise profile, wherein the reference device operates in a known undegraded state;
separate the set of time series signals into segments that correspond to the individual iterations of the exercise profile;
align and merge the segments to generate a merged reference fingerprint; and
train a machine learning model to detect anomalous departures from the known undegraded state based on the merged reference fingerprint.

11. The non-transitory computer-readable medium claim 10, wherein the instructions to align and merge the segments cause the computer to:
align the segments based on cross correlation coefficients between the segments to generate an initial reference fingerprint, wherein the coarse reference fingerprint is a merge of the aligned segments; and
realign the segments based on cross power spectral density between individual segments extracted from the initial reference fingerprint and the initial reference fingerprint to generate the merged reference fingerprint, wherein the merged reference fingerprint is a merge of the realigned segments.

12. The non-transitory computer-readable medium claim 10, wherein the instructions cause the computer to, before training the machine learning model:
ensemble average the merged reference fingerprint in a moving window; and
resample the ensemble-averaged merged reference fingerprint at a uniform interval.

13. The non-transitory computer-readable medium claim 10, wherein the instructions to generate the set of time series signals further cause the computer to:
accept the sensor readings of the reference device, wherein the sensor readings are sampled at a first sampling rate;
divide a frequency spectrum of the sensor readings into a plurality of frequency bins; and
sample the frequency bins at a second sampling rate to produce the set of time series signals, wherein the time series signals in the set of time series signals correspond to the frequency bins, and wherein the second sampling rate is lower than the first sampling rate.

14. The non-transitory computer-readable medium claim 10, wherein the instructions further cause the computer to:
accept field sensor readings of a field device, wherein the field sensor readings are sampled at a first sampling rate;
convert the field sensor readings to a field set of time series signals, wherein the field set of time series signals have a second sampling rate that is lower than the first sampling rate;
transmit the field set of time series signals to the trained machine learning model, wherein the second sampling rate reduces transmission bandwidth for the field sensor readings;
monitor the field set of time series signals with the trained machine learning model to detect an anomaly indicating degraded operation of the field device; and
in response to detecting the anomaly, generate an electronic alert that the field device exhibits the degraded operation.

15. A computing system, comprising:
at least one processor;
at least one memory connected to the at least one processor;
a non-transitory computer readable medium including instructions stored thereon that when executed by at least the processor cause the computing system to:
generate a set of time series signals from sensor readings of a reference device while the reference device is operated through multiple individual iterations of an exercise profile, wherein the reference device operates in a known undegraded state;
separate the set of time series signals into segments that correspond to the individual iterations of the exercise profile;
align and merge the segments to generate a merged reference fingerprint; and
train a machine learning model to detect anomalous departures from the known undegraded state based on the merged reference fingerprint.

16. The computing system of claim 15, wherein the instructions to align and merge the segments cause the computing system to align the segments in a first pass and refine the alignment of the segments in a second pass.

17. The computing system of claim 15, wherein the instructions to align and merge the segments cause the computing system to:
coarsely align the segments based on cross correlation coefficients between the segments to generate a coarse reference fingerprint, wherein the coarse reference fingerprint is a merge of the coarsely aligned segments; and
finely realign the segments based on cross power spectral density between individual segments extracted from the coarse reference fingerprint and the coarse reference fingerprint to generate the merged reference fingerprint, wherein the merged reference fingerprint is a merge of the finely realigned segments.

18. The computing system of claim 15, wherein the instructions further cause the computing system to, before training the machine learning model:
ensemble average the merged reference fingerprint in a moving window; and
resample the ensemble-averaged merged reference fingerprint at a uniform interval.

19. The computing system of claim 15, wherein the instructions to generate the set of time series signals further cause the computing system to:
accept the sensor readings of the reference device, wherein the sensor readings are vibration data, acoustic data, ultrasonic data, electromagnetic interference data, or infrared thermal imaging data sampled at a high frequency;
divide a frequency spectrum of the sensor readings into a plurality of frequency bins; and
sample the frequency bins to produce the set of time series signals, wherein the time series signals in the set of time series signals correspond to the frequency bins.

20. The computing system of claim 15, wherein the instructions further cause the computing system to:
monitor a field device with the trained machine learning model to detect an anomaly indicating degraded operation of the field device; and
in response to detecting the anomaly, generate an electronic alert that the field device exhibits the degraded operation.
